(19) United States
(12) Patent Application Publication
(10) Pub. No.: US 2006/0062481 A1
(43) Pub. Date: Mar. 23, 2006

(54) Apparatuses, computer program product and method for bit rate control of digital image encoder

(76) Inventor: Markus Suvanto, Oulu (FI)

Correspondence Address: YOUNG & THOMPSON, 745 SOUTH 23RD STREET, 2ND FLOOR, ARLINGTON, VA, 22202, US

(21) Appl. No.: 10/944,856

(22) Filed: Sep. 21, 2004

(51) Int. Cl. G06K 9/36

(52) U.S. Cl. 382/239

(57) ABSTRACT

Apparatuses, a computer program product and a method for controlling a bit rate of a digital image encoder. The bit rate controller includes a target cumulative distribution function computing mechanism predicting the number of encoded bits resulting from an encoding to be performed in the encoder; a counter mechanism counting the number of encoded bits resulting from the encoding; a check mechanism forming an error term from a comparison between a value of the counter and a corresponding value of the target cumulative distribution function; and a bit rate control mechanism adjusting a quantization parameter of the encoding to be continued on the basis of the error term.

### FIELD

The invention relates to a bit rate controller for a digital image encoder, an arrangement for bit rate control in a digital image encoder, a computer program product for bit rate control of a digital image encoder, an integrated digital image encoding circuit, and a method for controlling a bit rate in a digital image encoder.

### BACKGROUND

In digital image and video encoding, typically, different encoding or compression ratios are needed to ensure that the encoded image data fits the appropriate media, a wired/wireless transmission or storage medium, for example. Bit rate control handles balancing between the image quality and size of compressed encoded image data.

There are numerous methods for modifying the bit rate, which depend on the encoding standard used, for example. An MPEG-4 (Moving Picture Experts Group) standard provides a quantization parameter (QP) as a primary modifier of the bit rate and several others less significant modifiers, like frame skipping. Some methods relate more to the image quality than to the compression ratio. A selection between intra and inter frames is an example of such a method, although it affects both the image quality and the compression ratio. Traditionally, these parameters are modified beforehand on the basis of an analysis on the data to be encoded, but such methods are way too computing-intensive for real-time encoding. The latency of a few frames would probably solve this problem but with requirements for more memory and bus capacity.

The prior art ignores rate control in real-time encoding. An MPEG group presents a rate control in “MPEG-4 Video Verification Model VM16”, where, for example, a mean absolute difference for a current frame after motion compensation is required. It is clear that this kind of calculation is unsuitable for real-time encoding. Furthermore, the algorithm contains several model parameters and division operations making it difficult to implement as an application-specific integrated circuit, ASIC.

### BRIEF DESCRIPTION OF THE INVENTION

The present invention seeks to provide an improved a bit rate controller for a digital image encoder, an improved arrangement for bit rate control in a digital image encoder, an improved computer program product for bit rate control of a digital image encoder, an improved integrated digital image encoding circuit, and an improved method for controlling a bit rate in a digital image encoder.

According to an aspect of the invention, there is provided a bit rate controller for a digital image encoder, comprising: a target cumulative distribution function computing mechanism predicting the number of encoded bits resulting from an encoding to be performed in the encoder; a counter mechanism counting the number of encoded bits resulting from the encoding; a check mechanism forming an error term from a comparison between a value of the counter and a corresponding value of the target cumulative distribution function; and a bit rate control mechanism adjusting a quantization parameter of the encoding to be continued on the basis of the error term.

According to another aspect of the invention, there is provided an arrangement for bit rate control in a digital image encoder, comprising: means for computing a target cumulative distribution function predicting the number of encoded bits resulting from an encoding to be performed in the encoder; means for counting the number of encoded bits resulting from the encoding; means for forming an error term from a comparison between a value of the counter and a corresponding value of the target cumulative distribution function; and means for bit rate control by adjusting a quantization parameter of the encoding to be continued on the basis of the error term.

According to another aspect of the invention, there is provided a computer program product for bit rate control of a digital image encoder, comprising: a target cumulative distribution function computing module predicting the number of encoded bits resulting from an encoding to be performed in the encoder; a counter module counting the number of encoded bits resulting from the encoding; a check module forming an error term from a comparison between a value of the counter and a corresponding value of the target cumulative distribution function; and a bit rate control module adjusting a quantization parameter of the encoding to be continued on the basis of the error term.

According to another aspect of the invention, there is provided an integrated digital image encoding circuit comprising: a target cumulative distribution function computing block predicting the number of encoded bits resulting from an encoding to be performed; a counter block counting the number of encoded bits resulting from the encoding; a check block forming an error term from a comparison between a value of the counter and a corresponding value of the target cumulative distribution function; and a bit rate control block adjusting a quantization parameter of the encoding to be continued on the basis of the error term.

According to another aspect of the invention, there is provided a method for controlling a bit rate in a digital image encoder, comprising: computing a target cumulative distribution function predicting the number of encoded bits resulting from an encoding to be performed in the encoder; counting the number of encoded bits resulting from the encoding; forming an error term from a comparison between a value of the counter and a corresponding value of the target cumulative distribution function; and controlling a bit rate by adjusting a quantization parameter of the encoding to be continued on the basis of the error term.

The invention provides several advantages. It provides a bit rate controller whose internal memory needs and busload are minimized. The bit rate controller may be implemented by software or ASIC, by reason of nonexistent division operations and a small number of parameters. Ideally suited for low bit rate real-time encoding, the invention is also suitable for higher bit rates. The bit rate controller is adaptive, making a change of the quantization parameter slow and restful, thus eliminating unwanted oscillation.

### LIST OF DRAWINGS

In the following, the invention will be described in greater detail with reference to embodiments and the accompanying drawings, in which

FIG. 1 is a simplified block diagram illustrating an overview of a video encoder;

FIG. 2 illustrates consecutive images in a video sequence;

FIGS. 3, 4, 5 and 6 illustrate the function of a bit rate controller for images of FIG. 2;

FIG. 7 illustrates the behavior of a virtual buffer, while encoding images of FIG. 2; and

FIG. 8 is a flow chart illustrating a method for controlling a bit rate in a digital image encoder.

### DESCRIPTION OF EMBODIMENTS

Digital image encoding is well known to a person skilled in the art from standards and textbooks, e.g. from the following works which are incorporated herein by reference: Vasudev Bhaskaran and Konstantinos Konstantinides: Image and Video Compressing Standards—Algorithms and Architectures, Second Edition; and Kluwer Academic Publishers 1997, Chapter 6: The MPEG video standards, and Digital Video Processing, Prentice Hall Signal Processing Series, Chapter 6: Block Based Methods. Embodiments of digital image encoders are also disclosed in the Applicant's publications: WO 02/33979 A1, WO 02/062072 A1, WO 02/067590 A1, WO 02/078327 A1, and WO 03/043342 A1, incorporated herein as references.

Digital images to be encoded are typically still images or a video sequence made of individual successive images. A camera may form a matrix presenting the images as pixels. Luminance and chrominance may have separate matrixes. The data flow that presents the image as pixels is supplied to an encoder. It is also feasible to build a device where the data flow is transmitted to the encoder along a data transmission connection, for example, or from the memory means of a computer. In such a case, the purpose is to compress an uncompressed digital image with an encoder for forwarding or storage. The compressed image formed by the encoder is transmitted along a channel to a decoder. In principle, the decoder performs the same functions as the encoder when it forms an image, only inversely. The channel may be, for example, a fixed or a wireless data transmission connection. The channel may also be interpreted as a transmission path which is used for storing the image in a memory means, e.g. on a laser disc, and by means of which the image is read from the memory means and processed in the decoder. Encoding of another kind may also be performed on the compressed image to be transmitted on the channel, e.g. channel coding by a channel coder. A channel decoder decodes the channel coding. The encoder and decoder may be arranged in different devices, such as computers, subscriber terminals of different radio systems, e.g. mobile stations, or in other devices where an image is to be processed. The encoder and decoder can also be combined to make an image codec.

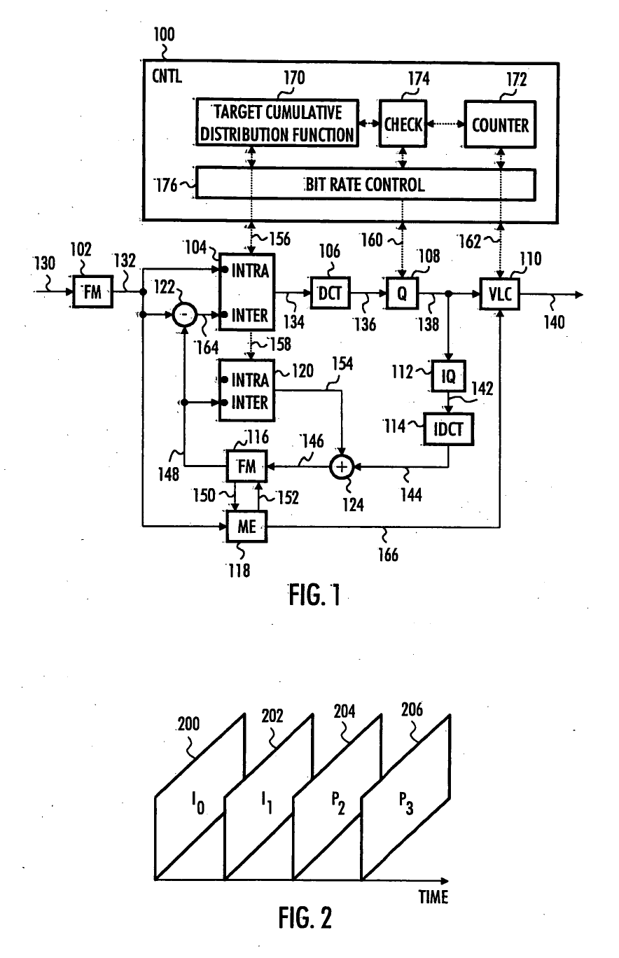

FIG. 1 describes the function of a video encoder on a theoretical level. In practice, the structure of the encoder is more complicated since a person skilled in the art adds necessary prior art features, such as timing and block-wise processing of images, to it. Successive images 130 are supplied to a frame buffer 102 for temporary storage. A single image 132 is supplied from the frame buffer 102 to a block 104, where the desired encoding mode is selected. The function of the device is controlled by a control part 100, which selects the desired encoding mode and informs the block 104 and a block 120 of the selected encoding mode 156, 158, for instance. The encoding mode may be intra-coding or inter-coding. No motion compensation is performed on an intra-coded image whereas an inter-coded image is compensated for motion. Usually the first image is intra-coded and the following images are inter-coded. Intra-images can also be transmitted after the first image if, for example, no sufficiently good motion vectors are found for the image to be encoded.

In the following, the function of the encoder will be described in a situation where intra-coding has been selected in the block 104.

The block 104 only receives the image 132 arriving from the frame buffer 102 as input for the intra-image. The image 132 obtained from the frame buffer 102 is supplied as such 134 to a discrete cosine transform block 106 where the discrete cosine transform is performed.

The image 136 on which discrete cosine transform has been performed is supplied to a quantization block 108, where quantization is performed, i.e. in principle each element of the image on which discrete cosine transform has been performed is divided by a constant and the result of the division is rounded to an integer. This constant may vary between different macro blocks. A quantization parameter, from which the divisors are calculated, is typically between 1 and 31. The more zeroes the block includes, the better it can be packed since no zeroes are transmitted to the channel.

Next, the quantized image 138 on which discrete cosine transform has been performed is supplied to a variable length coder 110, which outputs the encoded image 140 produced by the encoder.

In addition to the variable length coder 110, the quantized image 138 on which discrete cosine transform has been performed is taken from the quantization block 108 to an inverse quantization block 112, which performs inverse quantization on the input quantized image 138 on which the discrete cosine transform has been performed, i.e. restores it to an image 136 as accurately as possible. Next, the image 142 quantized inversely is supplied to an inverse discrete cosine transform block 114, where an inverse discrete cosine transform is performed. Since the discrete cosine transform is a lossfree transform and quantization is not, an image 144 does not completely correspond to the image 134. The purpose of inverse quantization and inverse discrete cosine transform is to produce an image in the encoder which is similar to the one produced by the decoder. The ‘decoded’ image 144 is then supplied to a block 124, where the part deleted from the image, i.e. difference data, would be added to it if the image had been inter-coded. Since the image in question is intra-coded, nothing is added to it. This decision is made by a block 120, where intra-coding is a pre-selected option, in which case there is nothing in the input of the block 120 and thus nothing is included in the output 154 connected to its block 124. Next, an intra-image 146 is stored in a frame buffer 116. Thus, a reconstructed image is stored in the frame buffer 116, i.e. the encoded image in the form in which it is after decoding performed in the decoder. There are two frame buffers: an image arriving at the device is stored in the first buffer 102 and the reconstructed ‘previous’ image is stored in the second buffer 116. The above described how to process an image for which intra-coding had been selected in the blocks 104 and 120.

Motion compensation can now be used in processing the next image.

In such a case, inter-coding is selected in the blocks 104 and 120. The image 116 stored in the frame buffer is now a reference image and the image to be encoded is the image 132 to be obtained next from the frame buffer 102. As is shown in FIG. 1, the next image is supplied to a motion estimation block 118 in addition to the block 104. The motion estimation block 118 also receives a reference image 150 from the frame buffer 116. The motion estimation block 118 searches the reference image for blocks corresponding to the blocks in the image to be encoded. Transitions between the blocks are expressed as motion vectors 152, 166, which are supplied both to the variable length coder and to the frame buffer 116.

The reference image 148 is taken from the frame buffer 116 to a block 122. The block 122 subtracts the reference image 148 from the image 132 to be encoded to provide difference data 164, which are supplied from the block 104 via the discrete cosine transform block 106 and quantization block 108 to the variable length coder 110.

The variable length coder 110 encodes the difference data 138 and motion vectors 166, in which case the output 140 of the variable length coder 110 provides an inter-coded image. The variable length coder 110 receives as inputs the quantized difference data 138 on which a discrete cosine transform has been performed, and motion vectors 166. The output 140 of the encoder thus provides the inter-coded image with compressed data, which represent the encoded image and the encoded image in relation to the reference image by means of motion vectors and difference data. The motion estimation is carried out using luminance blocks but the difference data to be encoded are calculated both for a luminance and a chrominance block.

Inverse quantization is also performed on the difference data 138 of the inter-coded image in the inverse quantization block 112 and inverse discrete cosine transform in the inverse discrete cosine transform block 114. The difference data 144 processed in this way are supplied to a block 124, where the previous image 154 subtracted in the encoding of the inter-image in question and obtained from the place indicated by the motion vector is added to the difference data. The sum 146 of the difference data and the previous image is supplied from block 124 to the frame buffer 116 to obtain a reconstructed image. The reconstructed image corresponds to the image obtained in the decoder when the encoding of the inter-coded image 140 is decoded. Thus, the frame buffer 116 has a reference image ready for encoding of the image 132 received next from the frame buffer 102.

The control block 100 controls the function of the encoder. In addition to selecting the encoding mode, it controls selection 160 of the correct quantization ratio and performance 162 of encoding with a variable length, for instance. The control block 100 may also control other encoder blocks even though this is not illustrated in FIG. 1. For example, the control block 100 controls the motion estimation block 118.

In a block based digital video encoding, the bit flow includes headers and encoded transformed coefficients. There are basically three different kinds of headers: top-level headers, frame-level headers and macro-block-level headers.

In practice, top-level headers appear within a bit flow only once, in the beginning; hence, the needed bit-amount is easily and precisely predictable. Furthermore, their bit-amount is only a small part of the whole bit flow; therefore, top-level headers can be ignored in rate control.

Frame-level headers are sent at the beginning of every frame, their bit-amount is quite static and their influence on the whole bit flow remains small. The rate control counts the frame level headers.

Macro-block-level headers consume a superior number of bits when compared to other headers. The macro-block level headers may include information about motion estimation, change of quantization parameter, encoding type, macro blocks, etc. The rate controller should consider that, for example, every change of quantization parameter consumes bits and causes a reduction in image quality.

However, the main part of the bit flow consists of VLC-codes (Variable Length Codes) that carry the transformed macro block coefficients. The transform used may be, for example, a DCT (Discrete Cosine Transform), like in several video coding standards, such as MPEG-1 and H-263. The rate between headers and VLC-codes, or the amount of VLC-codes, may be altered with the quantization, causing balancing between the image quality and bit rate.

The main idea of rate control is plain and simple: If the bit rate is higher than expected, the quantization level is increased, and if the bit rate is lower than expected, the quantization level is decreased. In an ideal case, the quantization parameter for every macro block of the whole video sequence could be set beforehand, but in practice it is not that simple because of the changing video information via motion estimation, etc.

When the quantization level is increased, the bit rate may become too low, whereas if the quantization level is decreased, it may result in the bit rate becoming too high; given the latency of the rate controller of the real-time video encoder, such strategy may cause too much fast variation in the quantization levels. Whatever the quantization level, it is clear that the bit load of a single frame differs from the expected bit rate. If we allow the bit load of a single frame to wander and set an object to correct the error in the future, a stable rate controller may be realized.

Certain variables can be defined for the use of the bit rate controller: Let B(t) describe the target bit flow (bit/s) at time t, f the target frame rate (frames per second) and bₙ the virtual bit load after the n^{th} frame. A theoretical bit load per frame is then
b₀=B(t₀)/f, (1)

which is used for the first frame (marked as a zero frame). The bit loads of subsequent frames can be defined with a recursive equation

$${b}_{n + 1} = {\int }_{{t}_{n}}^{{t}_{n + 1}} B ( t ) ⅆ t + {b}_{n} . \qquad ( 2 )$$

Mpeg-4 defines the time codes as follows:

vop_time_increment_resolution (tr); the smallest unit of time, a fraction of a second;

vop_time_increment (tvₙ); elapsed time as quantity of smallest units of time since the first encoded frame; and

time_increment (tiₙ); the amount of time that has elapsed since the previously encoded frame.

Using the time codes, the frame rate fₙ at the moment, when encoding frame n, may be expressed as
fₙ=tr/tiₙ. (3)

The allocated, or predicted, bit load baₙ for the frame n comes from an equation pair
ba₀=b₀, (4)
and
baₙ₊₁=bₙ₊₁−blₙ, (5)

where bin is the true bit load of frame n. Now, we can rewrite the equations (1) and (2) into forms
b₀=B₀/f₀, (6)
and
bₙ₊₁=(Bₙ₊₁tiₙ₊₁/tr)+bₙ, (7)

where Bₙ describes the bit flow of frame n. When counting is performed with integers, bₙ will slowly drift as n increases. This problem would be partly solved by the presumption that the bit flow would be stable, but this leads to another problem where tvₙ grows without limit. If we describe drifting with dₙ, for frame n, then d₀=0 and we can write
dₙ₊₁=(Bₙtvₙ/tr)−bₙ (8)

and furthermore
bₙ₊₁=(Bₙ₊₁tiₙ₊₁/tr)+bₙ+dₙ (9)

from (7) and (8).

From equations (5) and (7) we can write
baₙ₊₁=(Bₙ₊₁tiₙ₊₁/tr)+bₙ−blₙ. (10)

This is because the (bₙ−blₙ) remains small as the values of parameters bₙ and blₙ are at least supposed to be quite equal.

Overflows are preventable if modulos
tvₙ (mod tr),
bₙ (mod Bₙ) and
blₙ (mod Bₙ)

are used instead.

Before encoding a frame, a certain number of bits must be allocated for it. In an ideal case, the number of bits allocated would be constant, but in reality there are no such video sequences. The error between allocated and true bit loads must therefore be corrected during the encoding of the next frame. The error can be corrected as a whole in the next frame, or shared between several upcoming frames.

However, the basic problem still remains: What is the quantization parameter that produces the desired bit load? If there is no time constraint, a frame could be encoded with several different quantization parameter sequences, and the sequence that produces a result closest to the desired bit load could be selected. However, calculations must be fast in real-time applications. Traditionally, “source models” are used for modeling the video sequence to be encoded. These models usually predict the bit load for a selected quantization parameter.

Suppose that the quantization parameter is changeable only between two successive frames. Now, the purpose of the source model is to predict the bit load of the frame with the selected quantization parameter. As a function, it may be written as R(QP). Source models may contain several different parameters or variables, such as a frame type, quantization parameter, distributions, constants, etc., which are used to make R as close to the encoded bit stream as possible. It has been noticed that there is quite a strong linear correlation between zero DCT-coefficients after quantization and the final bit load of the frame. A linear source model
R(ρ)=θ(1−ρ) (11)

was created, where p stands for the relative number of zeros, and θ is the only parameter of this model. The linear source model is disclosed in an article by Zhihai He and Sanjit K. Mitra: A linear Source Model And a Unified Rate Control Algorithm for DCT Video Coding, IEEE Transactions on Circuits and Systems for Video Technology, 2000, incorporated herein as reference.

The function of a rate control with a source model on a macro block level will be explained next. First, a predictive bit load is allocated for the frame. Parameter θ is then initialized with a predefined value; a study has revealed that value 7 is ideal. A table of values of function R(ρ) is kept at a memory device. Quantization parameter is selected next using the R(ρ) information from the memory device. It is to be noted that curves R(QP) and R(ρ) correlate with consecutive frames and a reasonable rate controller may be developed for a real-time implementation.

The model parameter for frame level rate control is defined with equation
θ=bl/(P−Z), (12)

where P stands for the number of pixels in a frame, Z for the number of zeroes after quantization, and bl for a bit load, all for the previously encoded frame. The number of zeroes Z is also used for selecting the quantization parameter from a pre-made table of zero-QP-function.

Two consecutive frames do not necessarily correlate; thus true and allocated bit loads differ, leading to catastrophic oscillation of quantization. Recovery from the oscillation may take several seconds or frames. Such oscillation is (partly) avoidable by filtering consecutive quantization parameters so that the rate of change decreases with time. Another, simultaneous method is to modify quantization within the frame encoding, by macro block level rate control, for example. The blocking effect may then take place in the middle of the frame.

A bit rate controller for the digital image encoder may be implemented in the control block 100. A target cumulative distribution function computing mechanism 170 predicts the number of encoded bits resulting from an encoding to be performed in the encoder. A counter mechanism 172 counts the number of encoded bits resulting from the encoding. A check mechanism 174 forms an error term from a comparison between a value of the counter 172 and a corresponding value of the target cumulative distribution function 170. A bit rate control mechanism 176 adjusts a quantization parameter of the encoding to be continued on the basis of the error term.

Failed quantization changes are common during, for example, scene changes when frames fade to black for a short period. In this case, quantization is decreased because of the decreased bit loads of frames. When a new scene starts, the bit load rises rapidly while quantization remains low, again leading to catastrophic oscillation. In these situations, a linear target cumulative distribution takes place. In an embodiment, the target cumulative distribution function computing mechanism is a target linear cumulative distribution function computed in a non-correlating situation. The non-correlating situation may be encoding of a first frame, a discontinuous point in encoding, such as a change in encoding type (a change between intra and inter frames) or some other irregular situation. The check mechanism may operate at predetermined checkpoints during the encoding. A target linear cumulative distribution function Tᵢ for a checkpoint i is
Tᵢ₌₍baₙ/N)*Cᵢ, (13)

where baₙ is a bit load allocated to a frame n, N is the number of checkpoints, and Cᵢ is a number of a macro block at the checkpoint i.

In an embodiment, the target cumulative distribution function computing mechanism is a target adaptive cumulative distribution function computed in a correlating situation. The correlating situation may be encoding of correlating consecutive intra or inter frames. The check mechanism may operate at predetermined checkpoints during the encoding. The target adaptive cumulative distribution function Ti for a checkpoint i is
Tᵢ=(baₙ/blₙ₋₁)*blₙ₋₁(i), (14)

where baₙ is a bit load allocated to a frame n, and blₙ₋₁(i) is a bit load at the checkpoint i of a previous frame n−1. The target distribution follows the previous frame; thus, the catastrophic oscillation is avoided, even if the bit load varies significantly within the frame.

The quantization at the checkpoint i may be adjusted with the error term δᵢ, which follows equation
δᵢ =blₙ₋₁(i)−Tᵢ. (15)

Change of quantization ΔQP may be carried out by comparing the error term δᵢ with a predetermined limit value I as follows:

$$Δ QP = \{ \begin{matrix}- 2 , \text{if} δ < - 2 l \\ - 1 , \text{if} - 2 l \leq δ < - l \\ 1 , \text{if} l \leq δ < 2 l \\ 2 , \text{if} 2 l \leq δ .\end{matrix} \qquad ( 16 )$$

Some image encoding standards do not allow a single change of the quantization parameter greater than two.

As explained above, in an embodiment, the check mechanism may operate at predetermined checkpoints during the encoding. The predetermined checkpoints may include pre-determined transition points between two successive macro blocks, for example. The checkpoints may be predetermined also such that they are located at regular intervals through the frame. The target cumulative distribution function computing mechanism may operate at the checkpoint. The use of checkpoints is not mandatory; the operations described above may also be performed in a continuous fashion. The quantization parameter is, however, usually changeable only for each macro block or for each frame.

FIG. 2 illustrates consecutive images in a video sequence. There are two successive intra frames 200, 202, followed by two successive inter frames 204, 206.

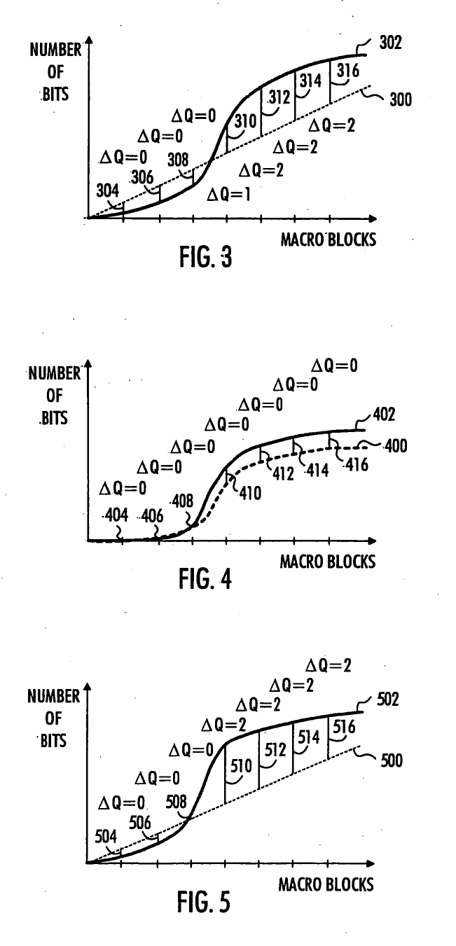

FIGS. 3, 4, 5 and 6 illustrate the function of a bit rate controller for the images of FIG. 2. In each FIG. 3, 4, 5 and 6, a dashed line curve 300, 400, 500, 600 is the target cumulative distribution function predicting the number of encoded bits resulting from an encoding to be performed in the encoder, the solid line curve 302, 402, 502, 602 is the counter counting the number of encoded bits resulting from the encoding, the vertical solid line 304, 306, 308, 310, 312, 314, 316, 404, 406, 408, 410, 412, 414, 416, 504, 506, 508, 510, 512, 514, 516 is the error term formed from a comparison between a value of the counter and a corresponding value of the target cumulative distribution function, and ΔQ illustrates a change in the quantization parameter of the encoding to be continued.

In FIG. 3, we use the target linear cumulative distribution function as this is the first, non-correlating intra image 200 of the video sequence. At the first three checkpoints, the quantization parameter change 304, 306, 308 is nil, because the true number of encoded bits corresponds well enough to the predicted number of encoded bits. In the last four checkpoints, the true number of encoded bits exceeds too much the predicted number of encoded bits, and the quantization parameter change 310, 312, 314, 316 is thus two. The change in the quantization parameter depends on a gap between the true and predicted number of encoded bits. Rate control-does not quite achieve the target number of bits, which is why the next target number of bits in FIG. 4 is smaller than in FIG. 3.

FIG. 4, we use the target adaptive cumulative distribution function for an image 202 as the encoding type of the previous image 200 was the same, i.e. the curve 400 for the predicted number of bits resembles the curve 302 for the true number of bits of the previous image 200. At all checkpoints, the true number of encoded bits corresponds well enough to the predicted number of encoded bits, and therefore all quantization parameter changes 404, 406, 408, 410, 412, 414, 416 are nil. It is to be noted that the rate control did not quite achieve the predicted number of bits.

In FIG. 5, we use the target linear cumulative distribution function for an image 204 as the encoding type of the previous image 202 was different. At the first three checkpoints, the quantization parameter change 504, 506, 508 is nil, because the true number of encoded bits corresponds well enough to the predicted number of encoded bits. In the last four checkpoints, the true number of encoded bits exceeds too much the predicted number of encoded bits, and the quantization parameter change 510, 512, 514, 516 is thus two.

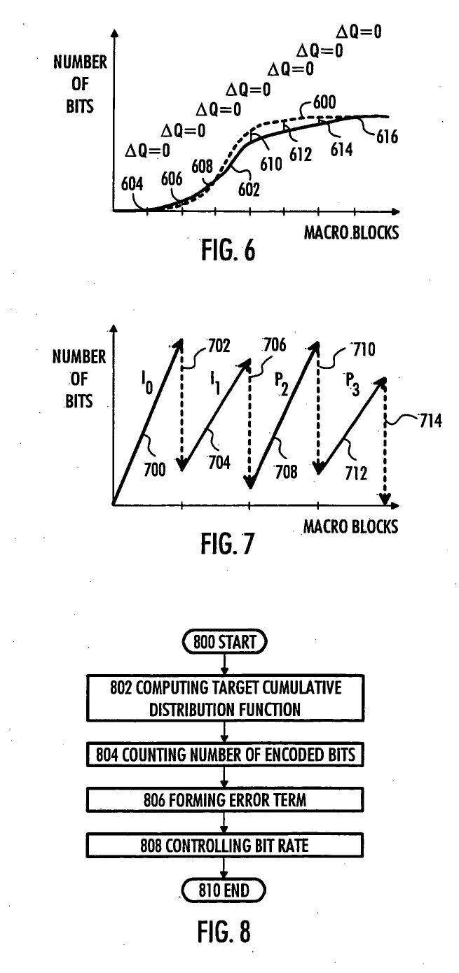

In FIG. 6, we use the target adaptive cumulative distribution function for an image 206 as the encoding type of the previous image 204 was the same, i.e. the curve 600 for the predicted number of bits resembles the curve 502 for the true number of bits of the previous image 204. At all checkpoints, the true number of encoded bits corresponds well enough to the predicted number of encoded bits; therefore, all quantization parameter changes 604, 606, 608, 610, 612, 614, 616 are nil. Ultimately, the rate control achieves the target bit rate precisely.

FIG. 7 illustrates the behavior of a virtual buffer, while encoding the images of FIG. 2. Solid line curves 700, 704, 708, 712 illustrate the total number of bits in the virtual buffer during the encoding of each image 200, 202, 204, 206, and dashed line curves 702, 706, 710, 714 illustrate the number of removed bits after the encoded image is ready.

The encoder mechanisms, or blocks, shown in FIG. 1 may be implemented as one or more integrated circuits, such as application-specific integrated circuits ASIC. Other embodiments are also feasible, such as a circuit built of separate logic components, or a processor with its software. A hybrid of these different embodiments is also feasible. When selecting the method of implementation, a person skilled in the art will consider the requirements set on the size and power consumption of the device, necessary processing capacity, production costs and production volumes, for example. One embodiment of the encoder is a computer program product for bit rate control of a digital image encoder. The computer program product includes computer executable instructions for causing a computer to perform rate control when the software is run. The computer program product may be embodied on a distribution medium readable by a computer. The distribution medium may be any means for distributing the software to customers, such as a computer readable program storage medium, a computer readable memory, a computer readable software distribution package, a computer readable signal, a computer readable telecommunications signal.

In the following, a method for controlling a bit rate in a digital image encoder will be described with reference to the flow chart shown in FIG. 8. The method starts in 800, where the encoder starts to encode an image. In 802, a target cumulative distribution function predicting the number of encoded bits resulting from an encoding to be performed in the encoder is computed. In 804, the number of encoded bits resulting from the encoding is counted. In 806, an error term from a comparison between a value of the counter and a corresponding value of the target cumulative distribution function is formed. In 808, a bit rate is controlled by adjusting a quantization parameter of the encoding to be continued on the basis of the error term. When no need for rate control exists any longer, if the encoding of a still image or a video sequence is ready, for example, the method ends in 810.

Even though the invention has been described above with reference to an example according to the accompanying drawings, it is clear that the invention is not restricted thereto but it can be modified in several ways within the scope of the appended claims.

1. A bit rate controller for a digital image encoder, comprising:
a target cumulative distribution function computing mechanism predicting the number of encoded bits resulting from an encoding to be performed in the encoder;
a counter mechanism counting the number of encoded bits resulting from the encoding;
a check mechanism forming an error term from a comparison between a value of the counter and a corresponding value of the target cumulative distribution function; and
a bit rate control mechanism adjusting a quantization parameter of the encoding to be continued on the basis of the error term.

2. The bit rate controller of claim 1, wherein the target cumulative distribution function computing mechanism comprises a target linear cumulative distribution function computed in a non-correlating situation.

3. The bit rate controller of claim 2, wherein the non-correlating situation comprises at least one of encoding of a first frame, and a discontinuous point in encoding.

4. The bit rate controller of claim 2, wherein the check mechanism operates at predetermined checkpoints during the encoding, and wherein the target linear cumulative distribution function Tᵢ for a checkpoint i is
Tᵢ=(baₙ/N)*Cᵢ,
where baₙ is a bit load allocated to a frame n, N is the number of the checkpoints, and Cᵢ is a number of a macro block at the checkpoint i.

5. The bit rate controller of claim 1, wherein the target cumulative distribution function computing mechanism comprises a target adaptive cumulative distribution function computed in a correlating situation.

6. The bit rate controller of claim 5, wherein the correlating situation comprises encoding of correlating consecutive intra or inter frames.

7. The bit rate controller of claim 5, wherein the check mechanism operates at predetermined checkpoints during the encoding, and wherein the target adaptive cumulative distribution function Ti for a checkpoint i is
Tᵢ=(baₙ/blₙ₋₁)*blₙ₋₁(i),
where baₙ is a bit load allocated to a frame n, and blₙ₋₁(i) is a bit load at the checkpoint i of a previous frame n−1.

8. The bit rate controller of claim 1, wherein the check mechanism operates at predetermined checkpoints during the encoding.

9. The bit rate controller of claim 8, wherein the target cumulative distribution function computing mechanism operates at the checkpoint.

10. The bit rate controller of claim 8, wherein the predetermined checkpoints comprise predetermined transition points between two successive macro blocks.

11. An arrangement for bit rate control in a digital image encoder, comprising:
means for computing a target cumulative distribution function predicting the number of encoded bits resulting from an encoding to be performed in the encoder;
means for counting the number of encoded bits resulting from the encoding;
means for forming an error term from a comparison between a value of the counter and a corresponding value of the target cumulative distribution function; and
means for bit rate control by adjusting a quantization parameter of the encoding to be continued on the basis of the error term.

12. A computer program product for bit rate control of a digital image encoder, comprising:
a target cumulative distribution function computing module predicting the number of encoded bits resulting from an encoding to be performed in the encoder;
a counter module counting the number of encoded bits resulting from the encoding;
a check module forming an error term from a comparison between a value of the counter and a corresponding value of the target cumulative distribution function; and
a bit rate control module adjusting a quantization parameter of the encoding to be continued on the basis of the error term.

13. The computer program product of claim 12, wherein the computer program product is embodied on a distribution medium readable by a computer.

14. The computer program product of claim 13, wherein the distribution medium comprises at least one of a computer readable program storage medium, a computer readable memory, a computer readable software distribution package, a computer readable signal, a computer readable telecommunications signal.

15. An integrated digital image encoding circuit comprising:
a target cumulative distribution function computing block predicting the number of encoded bits resulting from an encoding to be performed;
a counter block counting the number of encoded bits resulting from the encoding;
a check block forming an error term from a comparison between a value of the counter and a corresponding value of the target cumulative distribution function; and
a bit rate control block adjusting a quantization parameter of the encoding to be continued on the basis of the error term.

16. A method for controlling a bit rate in a digital image encoder, comprising:
computing a target cumulative distribution function predicting the number of encoded bits resulting from an encoding to be performed in the encoder;
counting the number of encoded bits resulting from the encoding;
forming an error term from a comparison between a value-of the counter and a corresponding value of the target cumulative distribution function; and
controlling a bit rate by adjusting a quantization parameter of the encoding to be continued on the basis of the error term.
